(19) United States
(12) Patent Application Publication
(10) Pub. No.: US 2002/0073017 A1
(43) Pub. Date: Jun. 13, 2002

(54) Method and system of presenting data and analysis for use in stock market trading

(75) Inventor: John Robertson, Victoria (CA)

Correspondence Address: SIMPSON & SIMPSON, PLLC, 5555 MAIN STREET, WILLIAMSVILLE, NY, 14221-5406, US

(73) Assignee: Robert Bender Consulting Ltd., Ottawa (CA)

(21) Appl. No.: 09/945,965

(22) Filed: Sep. 4, 2001

Related U.S. Application Data
(60) Provisional application No. 60/229,526, filed on Sep. 5, 2000.

(51) Int. Cl. G06F 17/60

(52) U.S. Cl. 705/37

(57) ABSTRACT

The present invention is directed to a method and system of presenting data and analysis for use in stock market trading. The method includes the steps of receiving stock information from a stock data provider, and then analyzing the stock information to generate historical stock trading information. Graphical displays showing the historical stock trading information along with basic stock information are then generated in such a manner to facilitate rapid understanding of the information being displayed.

### RELATED APPLICATION

This nonprovisional patent application claims the benefit of U.S. Provisional Application Serial No. 60/229,526, filed Sep. 5, 2000.

### FIELD OF THE INVENTION

The present invention relates in general to displaying stock information and more specifically to a method and system of presenting data and analysis for use in stock market trading.

### BACKGROUND OF THE INVENTION

Stock market forecasting and analysis tools have been used for decades by most investors and stock traders. Over the years, a number of these tools, in the form of analysis systems and graphical displays, have been created to assist investors and traders in attempting to predict market behavior of stocks. These tools have also allowed traders and investors to be better informed by supplying information regarding the historical transactions of the sale or purchase of stocks. The systems and graphical displays are generally used to display historical stock information such as historical stock prices and stock sale history along with basic stock information such as bid and ask prices. By providing such information, both traders and investors are able to make a more informed decision or analysis of the future of a stock in question. Use of these systems and displays has also enhanced the level of intuition an investor or trader may gain or may be able to impart to others regarding stocks. The graphical displays are generally generated for traders and investors in three-minute intervals; however, some graphical displays provide information in one-minute intervals.

However, providing information in either one or three-minute intervals does not allow for a true analysis of a stock and its fluctuations since many transactions may occur over the span of a minute which may lead to many stock price changes over a relatively short interval. Therefore, provision of stock information and analysis in smaller time frames would be beneficial.

Furthermore, many graphical displays presently provide only basic stock information such as a price versus time display that shows a stock's trading price at various intervals throughout a trading day. From these basic displays it is usually possible to ascertain the number of shares traded and the range of prices covered during the time interval. Therefore, the trader or investor is required to view many different graphical displays, each including similar, if not identical, basic stock information, to review numerous analysis systems and graphical displays in order to gain enough information to obtain an educated analysis of a stock.

Moreover, some prior art graphical displays are not designed for easy viewing and understanding due to the placement of various graphs within the displays, as well, as using only basic colours to differentiate between different stock information.

Therefore, there is provided a method of data presentation and analysis for use in stock market trading which overcomes the problems listed above. The present invention provides both basic stock information and historical stock information, in the form of various analysis systems and graphical displays, such that an investor or trader may have access to more than one analysis system at a time.

### SUMMARY OF THE INVENTION

There is provided a method and system of presenting data and analysis for use in stock market trading. Instead of simply providing basic stock information to a trader or investor, the method and system of the present invention also provides historical stock information, in the form of at least two graphical displays showing volume of sales, historical price and historical sales and purchases of a stock to assist a trader or investor in the analysis of a stock's future price trend. Examples of historical information graphical displays include a volume of sales display, a market maker graphical display, a trade bar graphical display, a bid/ask bar display and a histogram display. Preferably, the graphical display facilitates rapid understanding of the information being displayed by using many different indicia, such as colour, to distinguish between different stock information values.

Another advantage of the present invention is that the graphical displays are generated in short time intervals, with some being updated on a per second basis. By updating the displays in such a manner, the trader or investor may be able to obtain a greater understanding of transactions involving the stock and to gain enough information to formulate an educated analysis of the stock.

Also, by providing more than one analysis system or graphical display showing historical stock information, the trader or investor may be able to refer to a single system and analysis tool for both basic and historical stock information. Therefore, the trader or investor does not have to constantly toggle between multiple analysis tools but may simply have access to graphical displays in a single tool.

In one aspect of the present invention there is provided a method of presenting data and analysis for use in stock market trading comprising the steps of:

receiving stock information;

analyzing the stock information to generate historical stock trading information; and

generating at least two graphical displays for displaying the historical stock trading information.

In another aspect of the present invention, there is provided a system of presenting data and analysis for use in stock market trading comprising:

a basic stock information display; and

at least two graphical displays showing historical stock information.

### BRIEF DESCRIPTION OF THE DETAILED DRAWINGS

Embodiments of the present invention will be described by way of example only with reference to the accompanying drawings in which:

FIG. 1 is a prior art graphical display showing basic stock information;

FIG. 2 is a prior art graphical display showing historical stock information;

FIG. 3 is a flowchart outlining a method of presenting data and analysis for use in stock market trading;

FIG. 4 is a graphical display of basic stock information and a volume of sale display;

FIG. 4a is a graphical display of a volume of sale display;

FIG. 5 is a graphical display of basic stock information and a bid/ask bar display;

FIG. 5a is a graphical display of a bid/ask bar display;

FIG. 6 is a graphical display of a histogram;

FIG. 6a is a graphical display of a volume bar;

FIG. 6b is a graphical display of a colour code for use with the histogram of FIG. 6;

FIG. 6c is a graphical display of a three-minute volume histogram;

FIG. 6d is a graphical display of an overall volume histogram;

FIG. 7 is a market maker graphical display;

FIG. 8-11 are further examples of graphical displays; and

FIG. 12 is a trade bar graphical display.

### DETAILED DESCRIPTION OF THE PREFERRED EMBODIMENTS

The present invention is directed at a method and system of presenting data and analysis for use in stock market trading. The data and analysis is provided in the form of analysis systems and graphical displays which clearly show not only basic stock information such as stock sale price but historical stock information such as volume of sales, historical price and historical sales and purchases of a stock. By providing access to more than one graphical display of historical stock information, the investor/trader is not required to refer to a plurality of analysis tools in order to analyze the status or determine productivity of a stock.

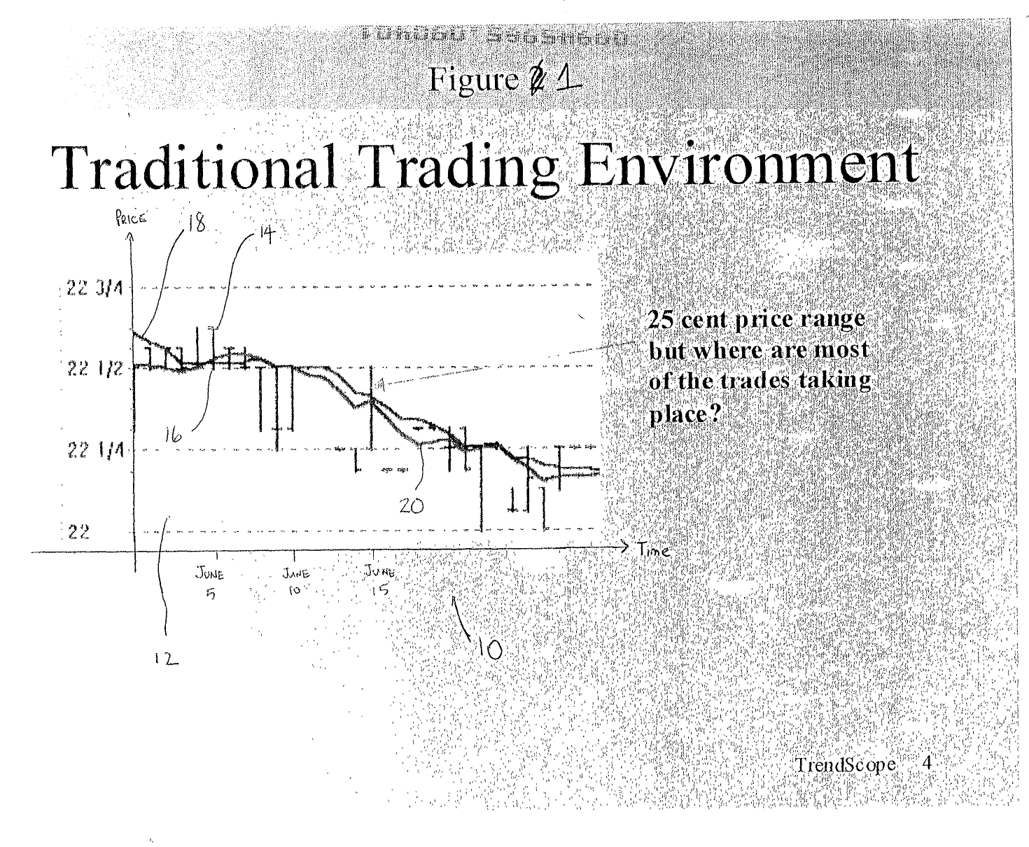

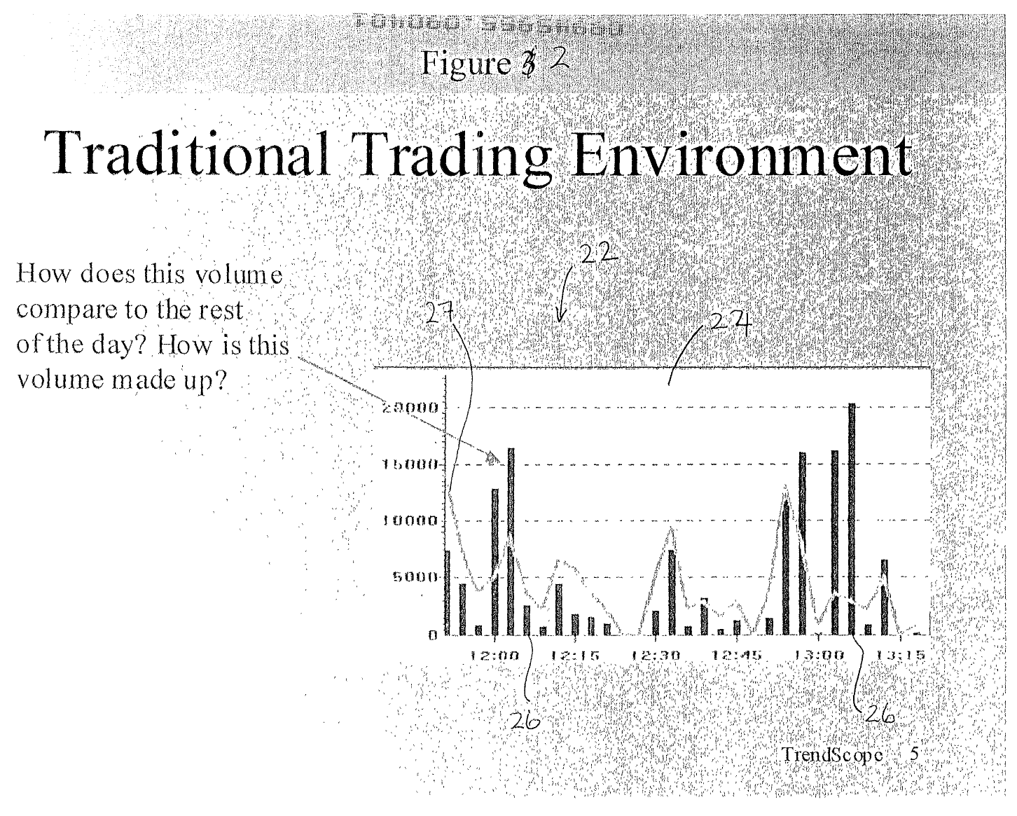

Turning to FIG. 1, a prior art graphical display of basic stock information is shown and is designated as 10. The display 10 is generally a price versus time graph 12 simply showing a highest stock purchase price 14 and a lowest stock purchase price 16 for a predetermined time interval. For the present graph 12, the time interval is a day. The graph 12 also includes a daily opening price line 18 and a daily closing price line 20 which respectively indicate the stock prices at the opening and closing of the trading day. In order to distinguish between the two lines, the daily opening price line 18 and the daily closing price line 20 are generally generated with different colours. However, with this prior art display 10, there is no information concerning the number of stock transactions at stock purchase prices between the highest stock purchase price 14 and the lowest stock purchase price 16.

One example of how historical stock information is displayed in a prior art graphical display is shown in FIG. 2. More specifically, FIG. 2 provides a volume of sales graphical display 22 for the trader or investor. The display 22 is a number of sales versus time graph 24. The graph 22 includes volume bars 26 which display the number of stock transactions over a predetermined time interval which, in the present display 22 is three minutes. The prior art display 22 also provides a line 27 indicating a moving average price of the stock transaction. However, the prior art graphical display 22 does not provide a comparison between the present volume of stock transactions and the volume of transactions in the past.

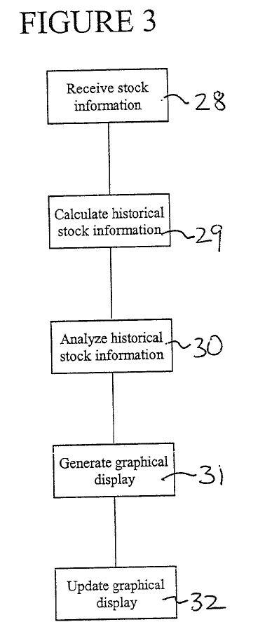

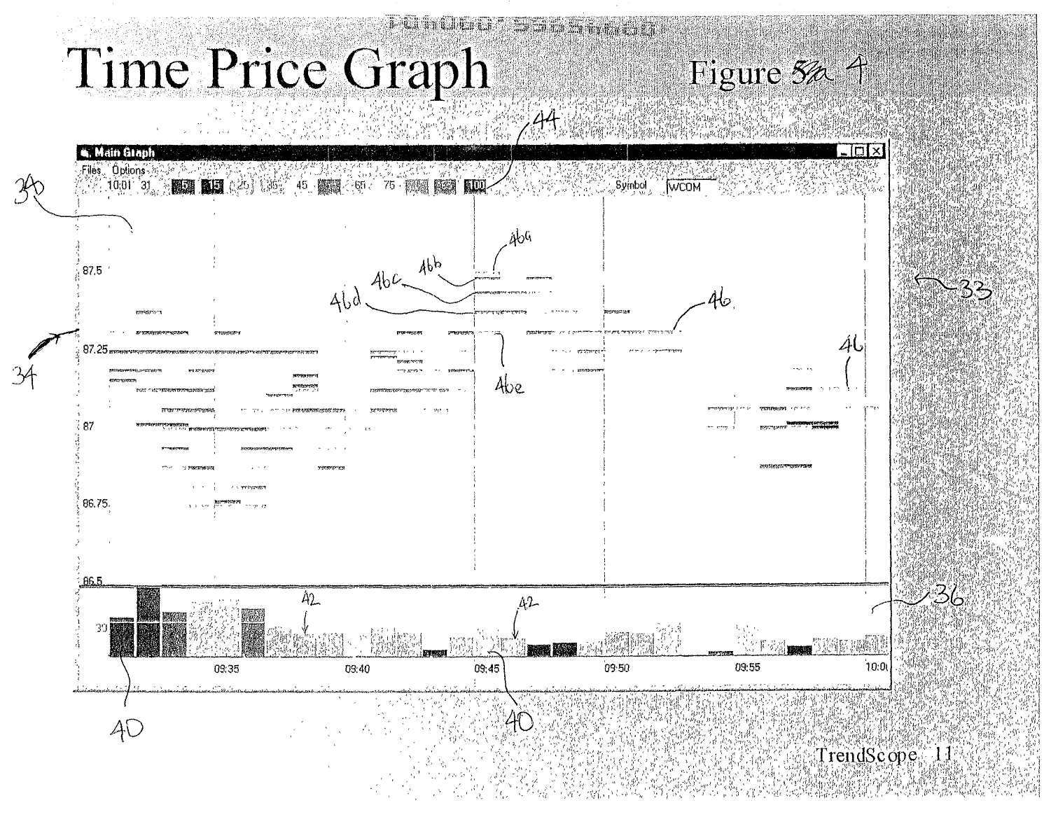

Turning to FIG. 3, a flowchart is shown outlining a method in accordance with the present invention. As will be understood by one skilled in the art, in order to present data and analysis for use in stock market trading, stock information, in the form of NASDAQ Level II data or equivalent data, is transmitted from a stock data provider to the analysis tool (step 28). It will be understood that the analysis tool generates the analysis systems and the graphical displays. An analysis tool is simply a tool which receives stock information and performs an analysis of the stock information in order to generate the analysis systems and graphical displays. NASDAQ Level II data provides information concerning bid offers, ask offers, size of each offer (the order size) and the market makers making the offers. This data is updated dynamically, as stock transactions occur. Therefore, for an illiquid stock, the level II data remains static, however, for a volatile liquid stock, the level II data is constantly updated. This information is sent on a real-time basis or whenever the data is updated. The analysis tool then performs a predetermined analysis of the Level II data to calculate historical stock information (step 29). This predetermined analysis is performed by a software module in order to re-arrange the Level II data to a format which is readable by the tool. The information is then sorted by the tool which then analyzes the re-arranged Level II data (step 30) to a readable format such that at least two graphical displays may be generated (step 31). To provide current information to the trader/investor, the graphical displays are preferably updated over short time intervals (step 32).

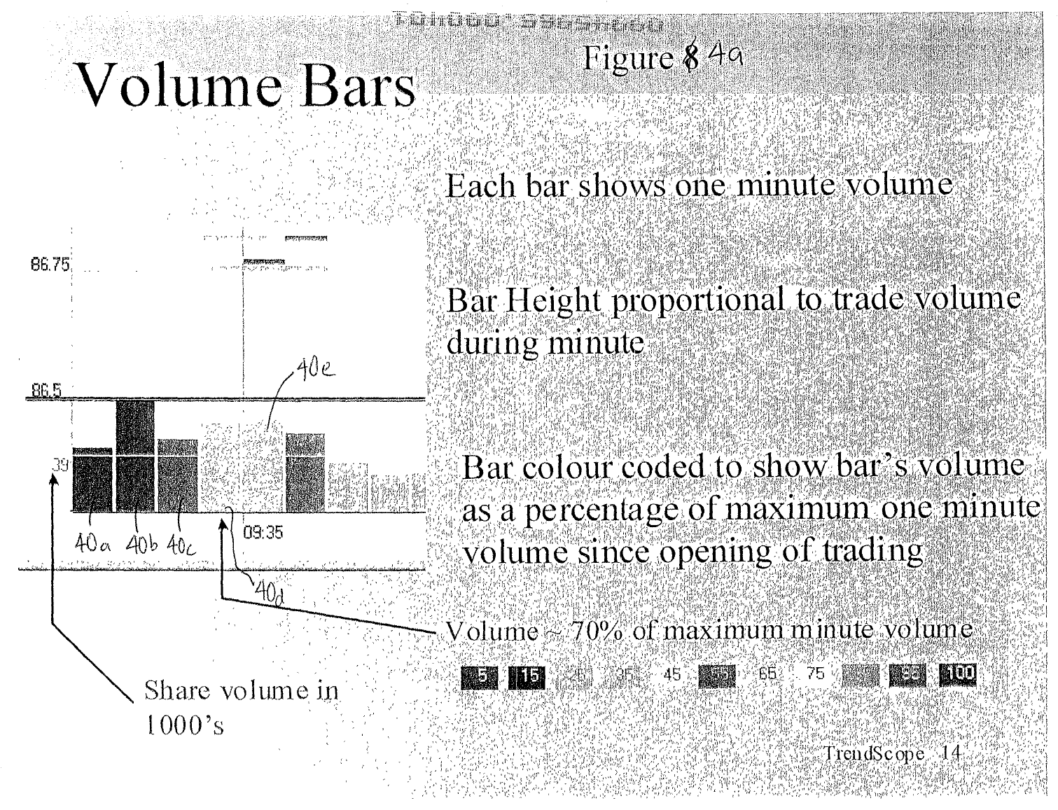

FIG. 4 provides a graphical display 33 including both a basic stock information graphical display 34 and a volume of sales graphical display 36. The graphical display basic stock information graphical display 34 is simply a price versus time graph 38 with price on the Y-axis and time on the X-axis. In this graph 38, the Y-axis increases in $0.25 increments while the X-axis increases in 5-minute intervals. However, it will be understood that stock information is being provided to the system of the present invention in real-time using time intervals as short as 15 seconds. Bars 40 located in the volume of sales graphical display 36 at a bottom of the graphical display 32 provide a colour-coded display of the volume of sales during each time interval as a percentage of the historical maximum interval volume of the present trading day up to that moment in time. It will be understood that differing volume percentages may be distinguished by different indicia such as colour and by using bar heights 42. Colour scale 44 is an example of how the bars 40 may be distinguished. Turning to FIG. 4a, a more detailed view of the volume of sales graphical display 36 is shown. Using the colour scale 44, FIG. 4a shows that at 9:31, a maximum volume of sales is attained as indicated by bar 40a. Subsequently, at time 9:32, a new maximum volume of sales is attained and is indicated by bar 40b. It will be understood that since a new maximum volume of sales has been attained, both the previous maximum volume of sales bar 40a and current maximum volume of sales bar 40b are shown in the same colour, namely red which according to the colour scale 44 indicates 100%. At time 9:33, the volume of sales is approximately 55% of the maximum volume of sales (9:32) for the present trading day. Bar 40c indicates this percentage via its colour (which corresponds to the colour scale 44). Further, at 9:34, the volume of sales is shown to be approximately 65% of the maximum volume as shown by bar 40d. The method and analysis tool of the present invention continuously generates volume bars 40 displaying the volume corresponding to the Level II data being transmitted from the stock data provider.

The basic stock information graphical display 34 of FIG. 4 displays a percentage of stock sales on a minute-by-minute basis. The percentage and price of the stock transactions are displayed by bars 46 and are colour-coded corresponding to the colour scale 44.

It will be understood that the length of the bars 46 may also be used to indicate the percentage of the stock transactions. The price at which the stock is sold is also displayed. For example, with respect to the 9:45 time interval, stocks were sold at five different prices. The approximate prices of the stocks being sold were $87.50 (bar 46a), $87.49 (bar 46b), $87.45 (bar 46c), $87.40 (bar 46d) and $87.35 (bar 46e). As shown by the colour coding, between 15 and 25% of the stocks sold in the 9:45 time interval was for $87.50 (bar 46a), 0 and 5% for $87.49 (bar 46b), 5 and 15% for $87.45 (bar 46c), 45 and 55% for $87.40 (bar 46d) and 15 and 25% for $87.35 (bar 46e). The length of the bars 46 also help to indicate the approximate volume of stocks sold at each price level.

It will be understood that by providing colour-coded percentage bars 40 and 46, a trader or investor may be provided with a graphical display which facilitates rapid understanding of the information being displayed in order to analyze the information concerning a stock. By providing both basic stock information and historical stock information in real-time, a new level of information is imparted.

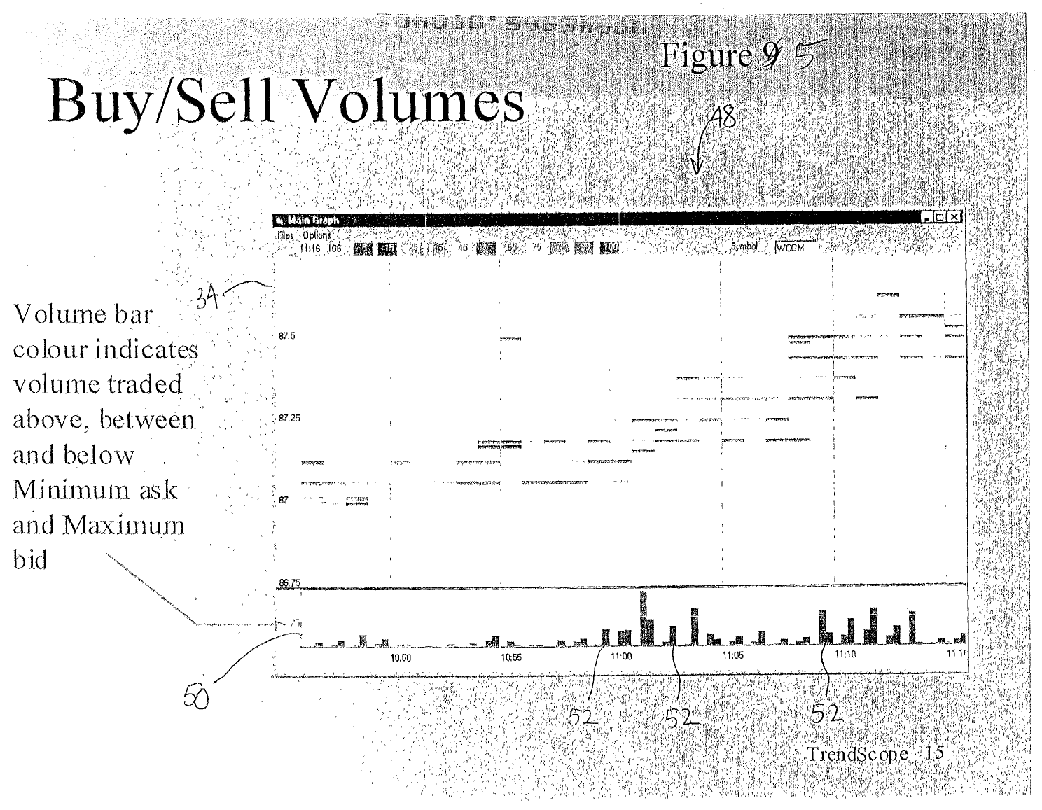

Turning to FIG. 5, a graphical display 48 including the basic stock information graphical display 34 is shown along with a bid/ask bar graphical display 50. The bid/ask bars graphical display 50 provides a second aspect to the analysis system of the present invention in presenting data and analysis for stock market trading. As more clearly shown in FIG. 5a, bid/ask bars 52 provide information concerning the volume of sales at specific prices. More specifically, the bid/ask bars 52 provide information concerning the volume traded when the maximum bid < the trade price > the minimum ask price (bar 52a), the volume traded when a trade price is ≦ a maximum bid (bar 52b) and the volume traded when the trade price is ≧ the minimum ask price (bar 52c). As can be seen, the bid/ask bars 52 are displayed side by side to facilitate comparison of relative sale volumes between the different bid/ask bars 52. The bars 52 are also colour-coded to more clearly distinguish between the different volumes within the one minute time interval. As will be understood by one skilled in the art, a greater volume of trades when the trade price is >the minimum ask price (bar 52c) indicates that the stock price may be rising in the near future since many investors are purchasing the stock.

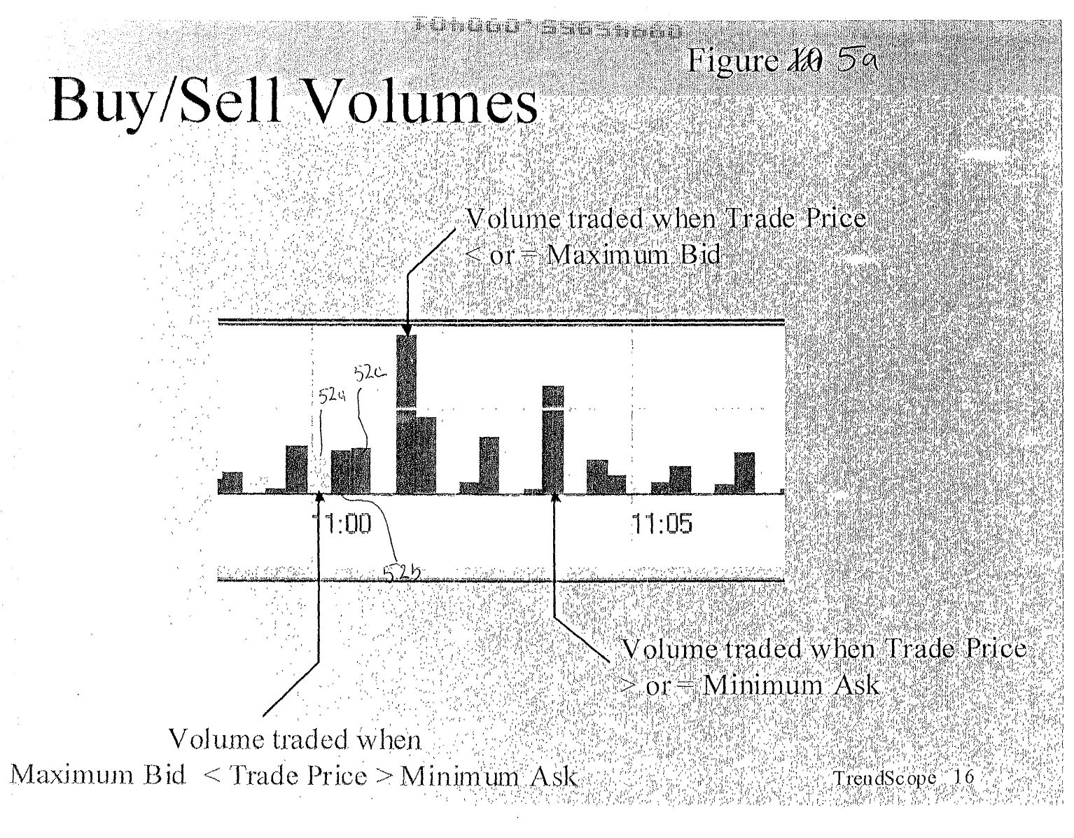

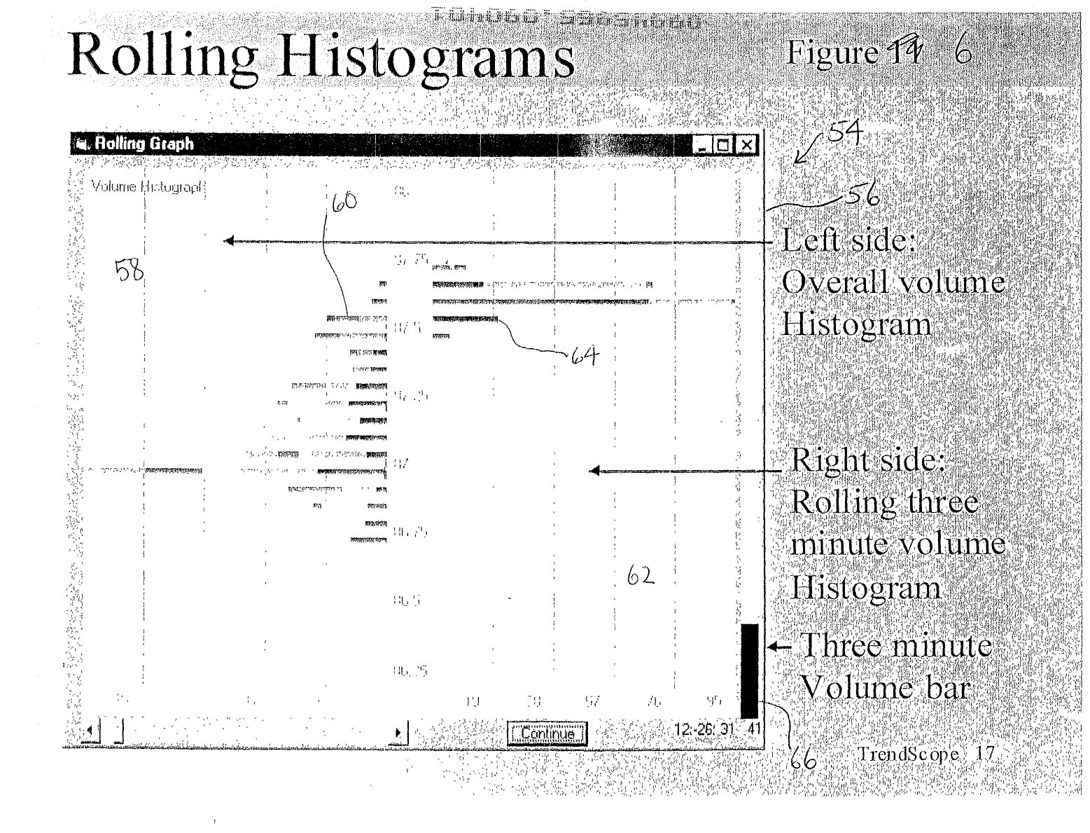

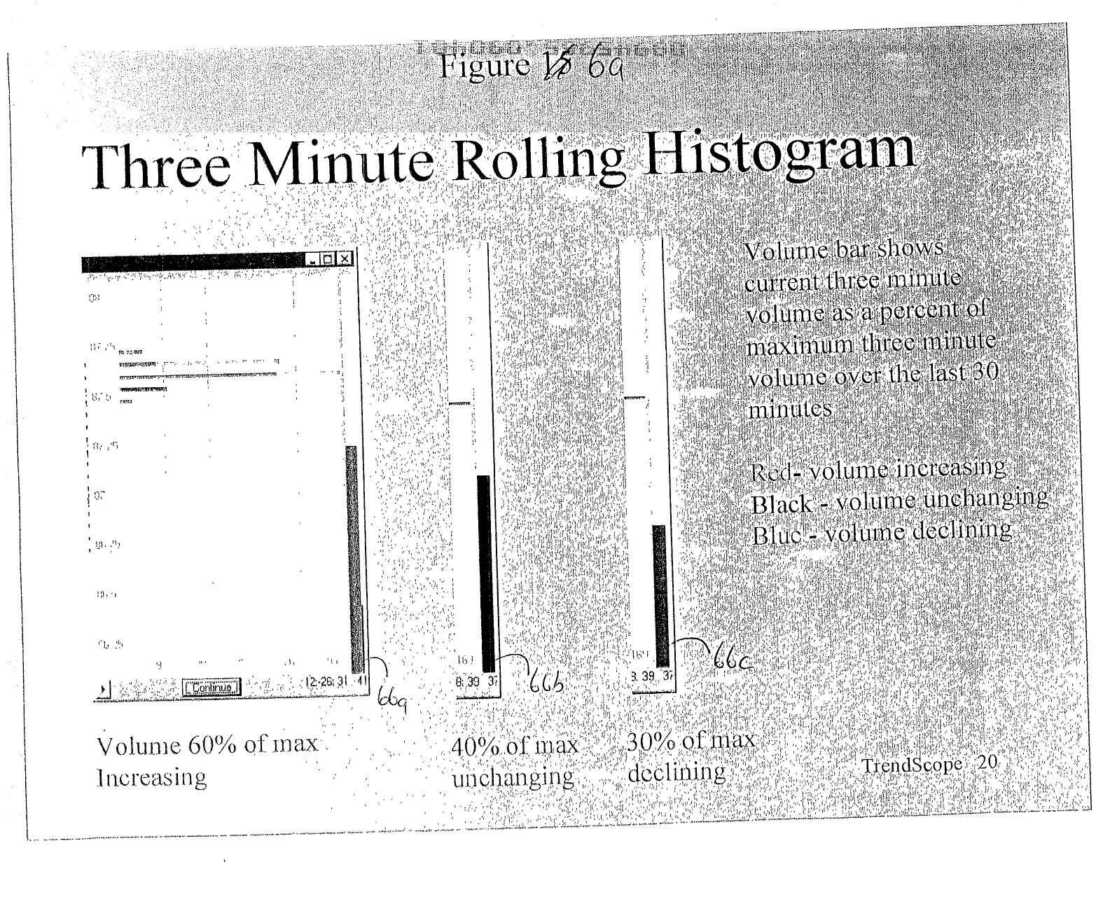

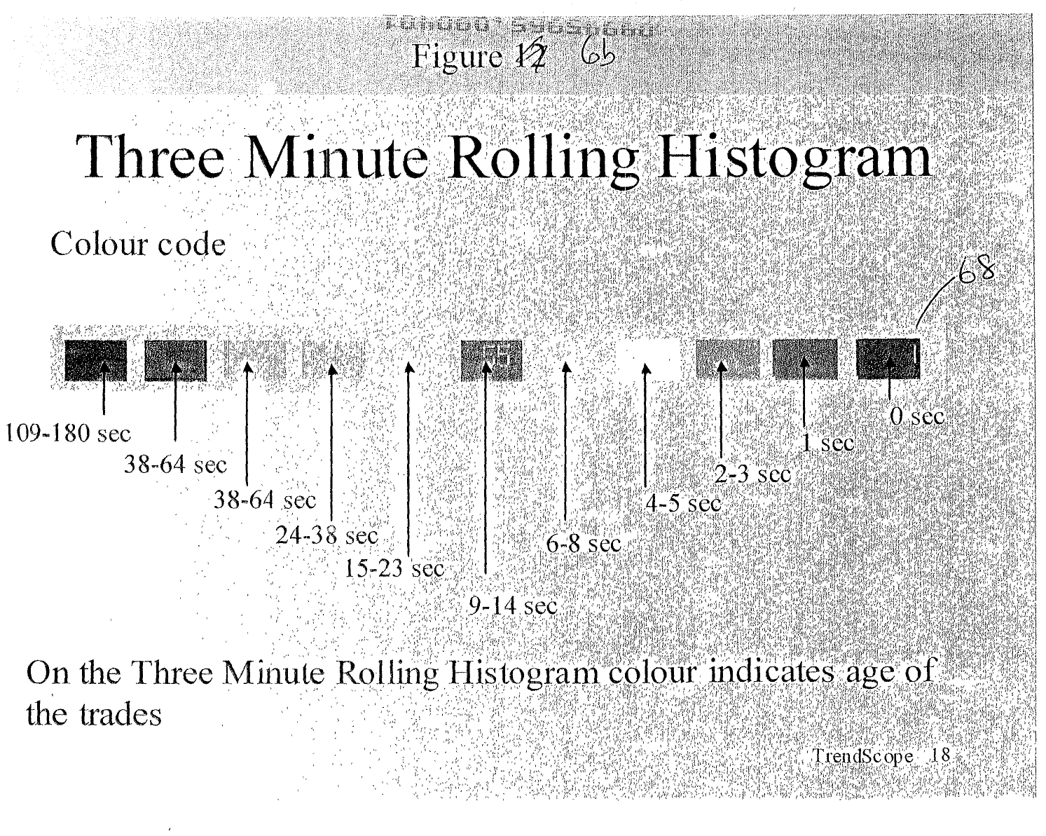

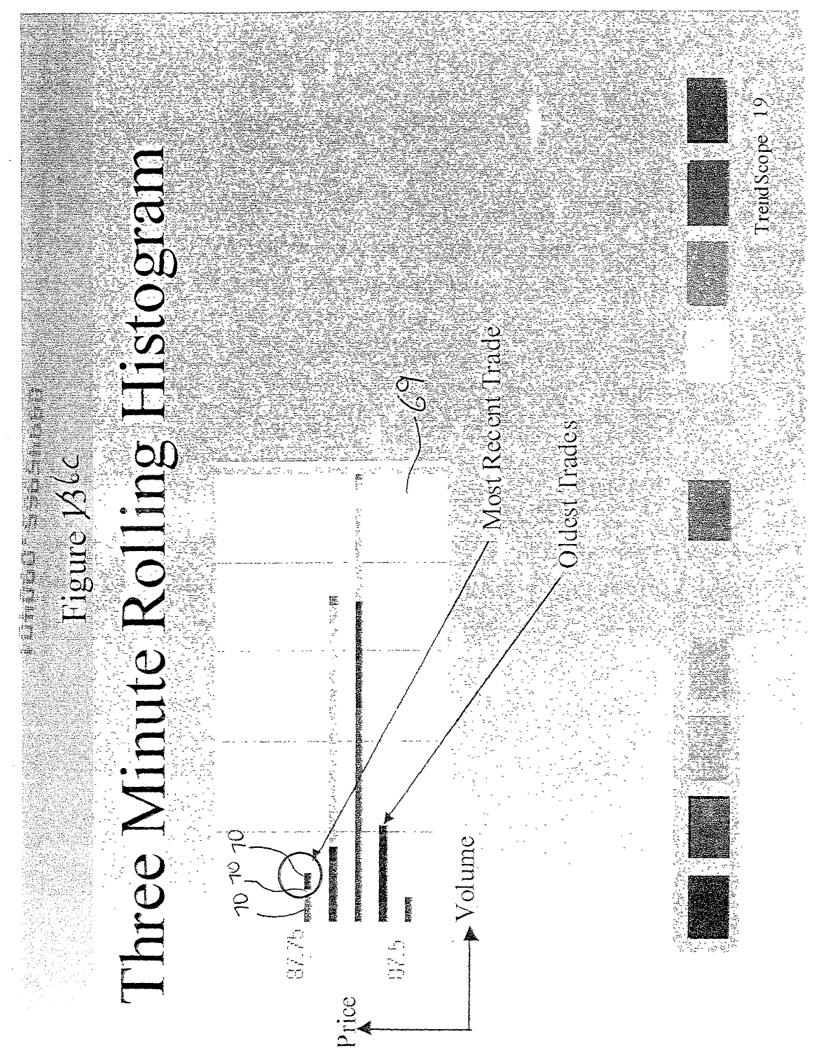

Yet another aspect of the present invention is a graphical display 54 for the provision of a histogram to the trader or investor. A histogram is simply a representation of a frequency distribution by means of rectangles. FIG. 6 shows the preferred rolling histogram graphical display 56 provided by the present invention. It will be understood that the rolling histogram graphical display 56 shown is simply one manner of presenting a histogram and other types may be used. On a left hand side 58 of the rolling histogram graphical display 56, an overall volume histogram 60 is shown while on a right hand side 62 of the rolling histogram graphical display 56, a rolling three-minute volume histogram 64 is shown.

The three-minute volume histogram 64 acts in a similar manner to a ticker in displaying real-time stock transaction information wherein the information is being updated on a per second basis to provide up-to-date information concerning stock transactions. As shown in FIG. 6a, the volume bar 66 may be colour coded to indicate the current volume activity of the stock relative to a predetermined historical volume while the height of the bar indicates the activity level of the sales. More specifically, in the preferred embodiment, the volume of the current 180 sec period is compared to the volume of the 180 sec ending one second earlier. With respect to the colour-coding, red (bar 66a) may indicate an increased volume of sales, a black bar (bar 66b) may indicate an unchanging volume of sales and a blue bar (bar 66c) may indicate a declining volume of sales.

Each stock transaction is displayed according to price and may be colour coded (according to a colour scale 68 as shown in FIG. 6b) with respect to price position according to time within the three-minute interval. Using the colour scale 68 of FIG. 6b, the age of the stock transactions may be indicated. As shown in FIG. 6c, a more detailed view of the three-minute histogram 64 using a price versus volume graph 69 is shown. Each length of a bar 70 represents a volume of stock transactions at that price within the three-minute interval. From the figure, it may be noted that at a price of $87.75, stock transactions were initiated between 9-14 seconds prior during the current three minute time interval and continue to the present time. For the price of $87.55, sales transactions were initiated between 109-180 seconds prior and no subsequent transactions have been made.

Similar to the three-minute volume histogram 64 is the overall volume histogram 60 with the only difference being that the volumes shown in the overall volume histogram 60 indicate the trades since the opening of the present trading day. As shown in FIG. 6d, in the preferred embodiment, the overall volume histogram is divided into equal sized time intervals 71 for easy display to the trader or investor. The number of time intervals is selected by the person implementing the present invention.

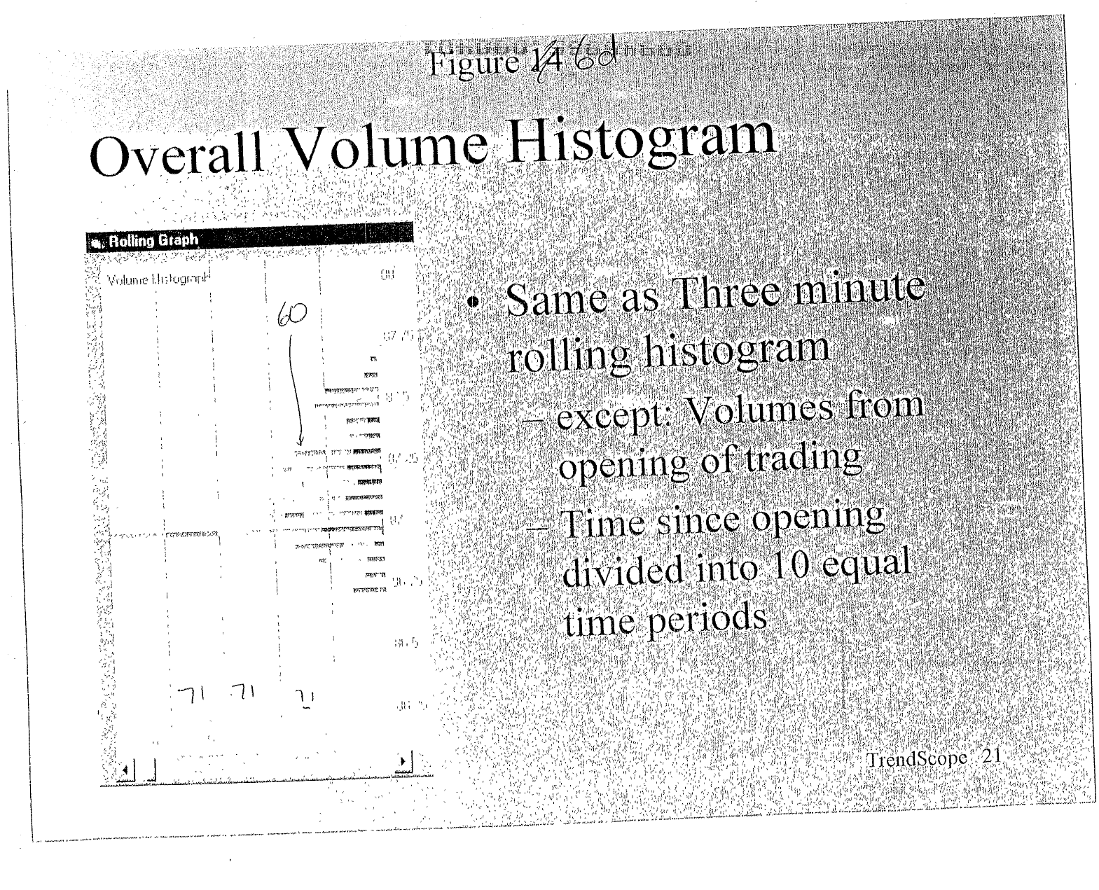

Turning to FIG. 7, a graphical display 72 of a market maker graphical display 74 is shown. On a left hand side 76 of the graphical display 72 is a market maker section 77 outlining the bids and asks provided by market makers. Although not shown, it will be understood that asks and bids of Electronic Communication Networks (ECN) may also be shown. In order to distinguish between the different bids and asks and the different market makers and ECNs, a colour coded system may be used. The actions and details of market makers and ECNs will be well known by one skilled in the art. Looking more closely at the left hand side 76, an ask section 78 displays the price of asks being placed/offered by the market makers and a bid section 80 displays the price of bids being placed/offered by the market makers. It can be seen that the asks are detailed by red bars 82 and the bids are detailed by blue bars 84. It should be noted that there may be asks at price levels included in the bid section 80 such as at $87.50. The left hand side 76 simply provides a general overview of market makers bids and quotes to assist the trader/investor in understand the market for the stock. On a right hand side 86 of the graphical display 72, a display similar to the three-minute volume histogram 64 is shown. There is also preferably provided a three-minute volume bar 66.

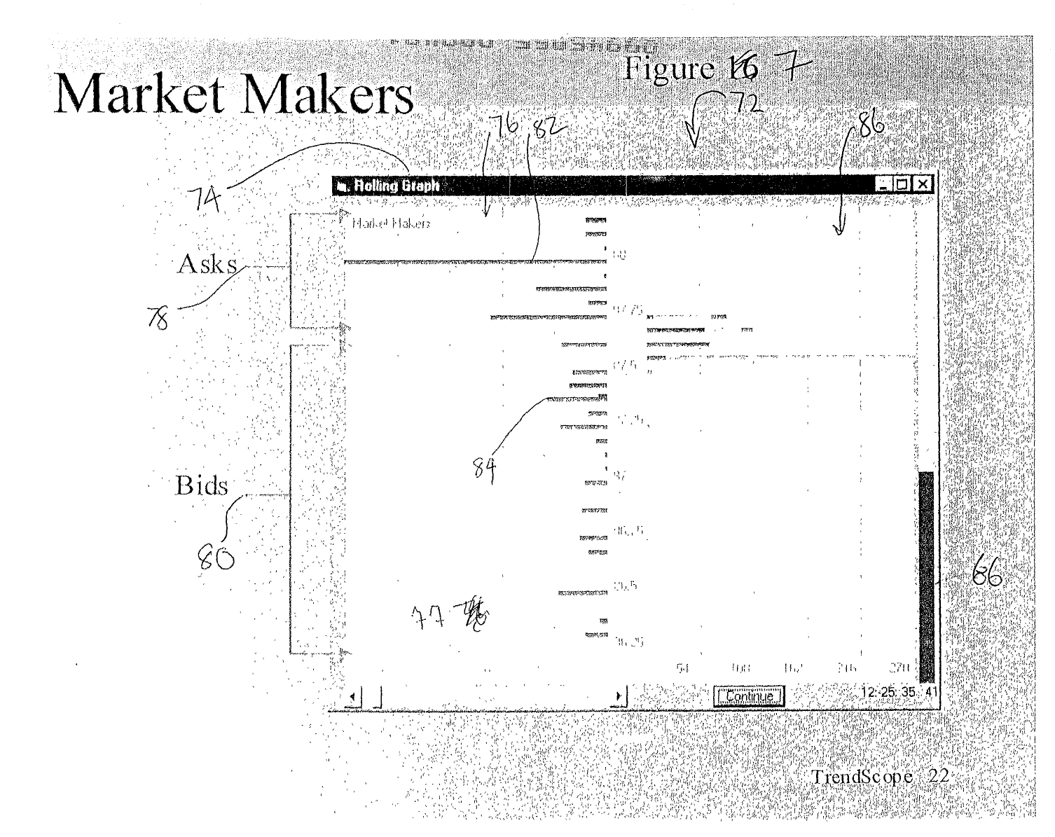

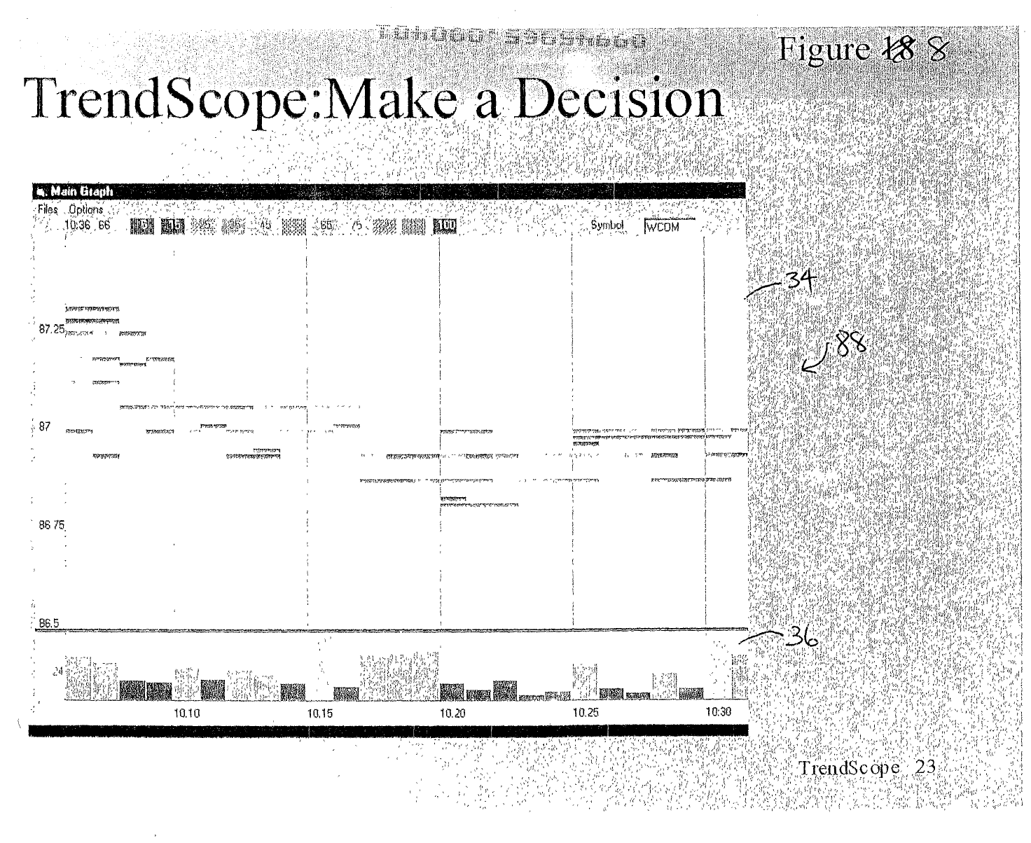

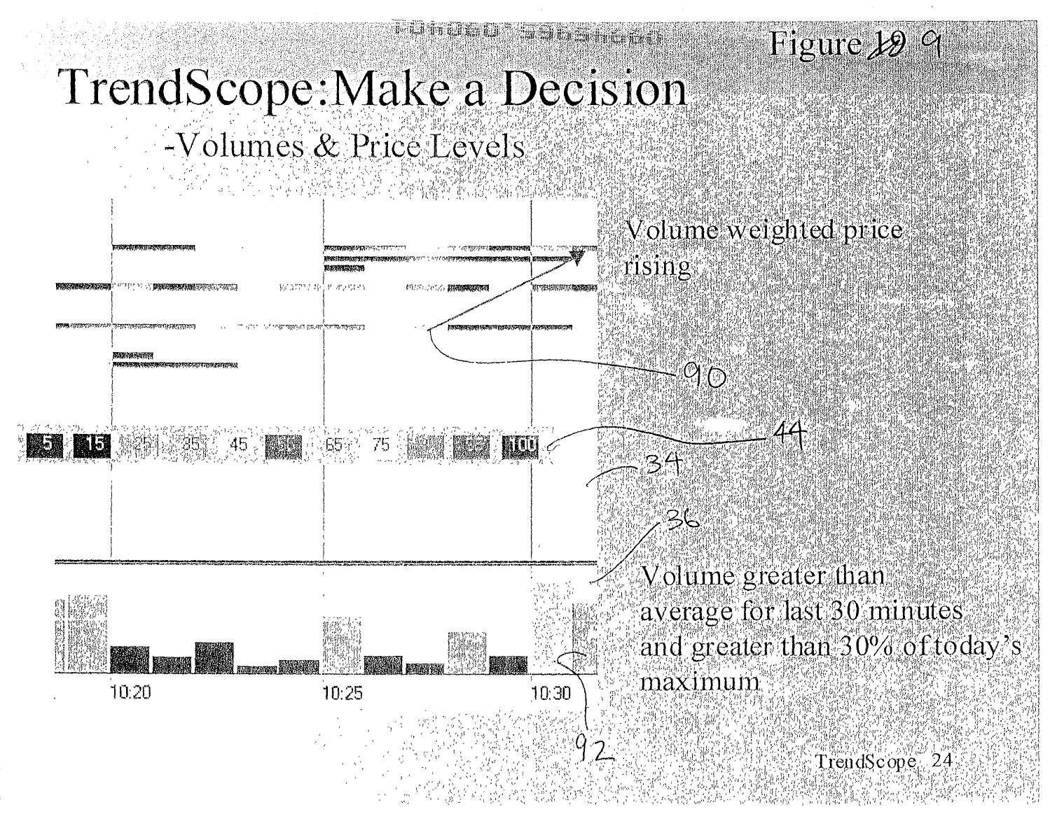

Turning to FIGS. 8-11, an example for using the analysis tool of the present invention is shown. FIG. 8 is a graphical display 88 including the basic stock information display 34 and the volume of sales graphical display 36. Initially, a trader or investor reviews the graphical display 88 to locate trends in stock transactions in order to gain a better understanding of the stock's performance during the present trading day. FIG. 9 provides a more detailed view of the graphical display 88. As shown by arrow 90, the volume weighted price of the stock being research is rising. A glance at the bar 92 for the 10:31 time interval of the volume of sales graphical display 36 shows that the volume of sales for the present time interval is greater than the average for the last thirty minutes as well as greater than 30% (via the colour coding) of the present day's maximum.

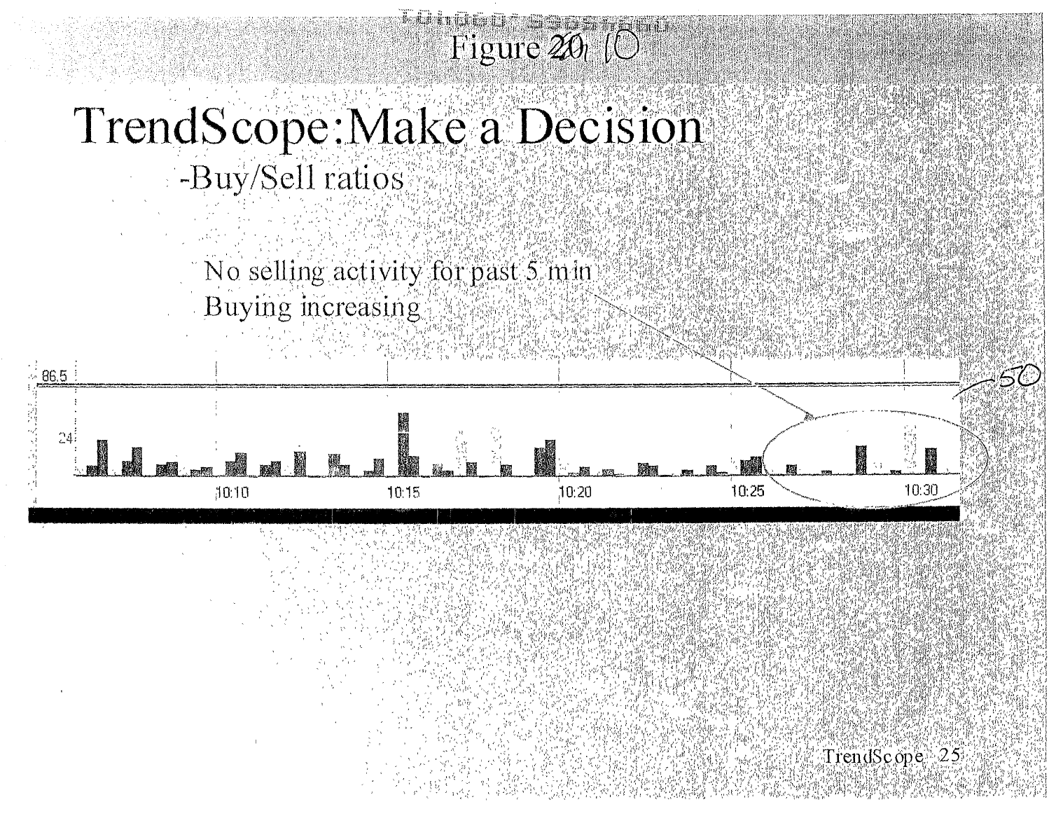

By toggling the display 88, the bid/ask bar display 50, as shown in FIG. 10, may be viewed by trader or investor. During the time frame from 10:26-10:30, the bid/ask bar display 50 indicates that there are no sales where the sale price is ≦ the maximum price bid. This suggests that stock purchases are increasing and that there is little or no selling of stocks by investors or traders. The information from these displays 34, 36 and 50 provide the investor or trader more in-depth information regarding the stock in question. By having the information updated on a real-time basis, the trader or investor may be able to more quickly arrive at a decision as to whether or not to purchase the stock.

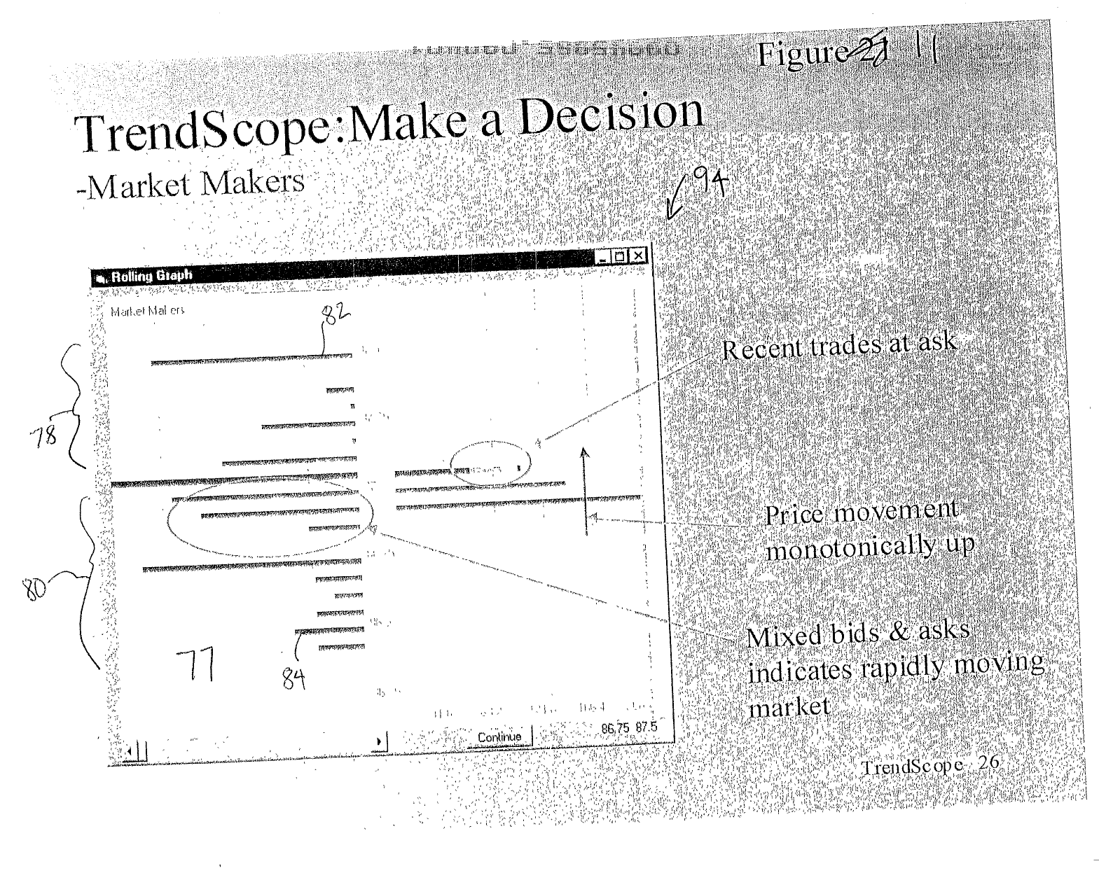

Referring now to FIG. 11, a graphical display 94 is shown. As described in FIG. 7, the market maker section 77 of the graphical display 94 provides the bid section 80 and the ask section 78. Asks (in red bars 82) and bids (in blue bars 84) being offered by the market makers are shown. The presence of mixed bids and asks indicate a rapidly moving market which would suggest to the trader or investor that the market is quite liquid. On the right hand side of the graphical display 94, using the colour code suggested in FIG. 6b, most recent stock transactions are occurring at $87.25. Therefore by reviewing the graphical displays provided in FIGS. 7-11, an investor or trader may be able to make an informed decision regarding a stock.

Furthermore, it will be understood that each of the graphical displays may be toggled such that the trader/investor may easily switch between the volume bar display of FIG. 4 and the bid/ask bars display as shown in FIG. 5 or any of the different graphical displays.

It will also be understood that although the present invention has been discussed with regard to stock trading, the graphical displays may also be used to show other forms of market trading such as bonds, currencies, options, commodities or futures.

It will also be understood that the bid/ask bars may be shown in a graphical display on a per price basis for a three minute interval. Therefore, the trader or investor may be able to understand the trade prices in relation to bids and asks over three minute intervals.

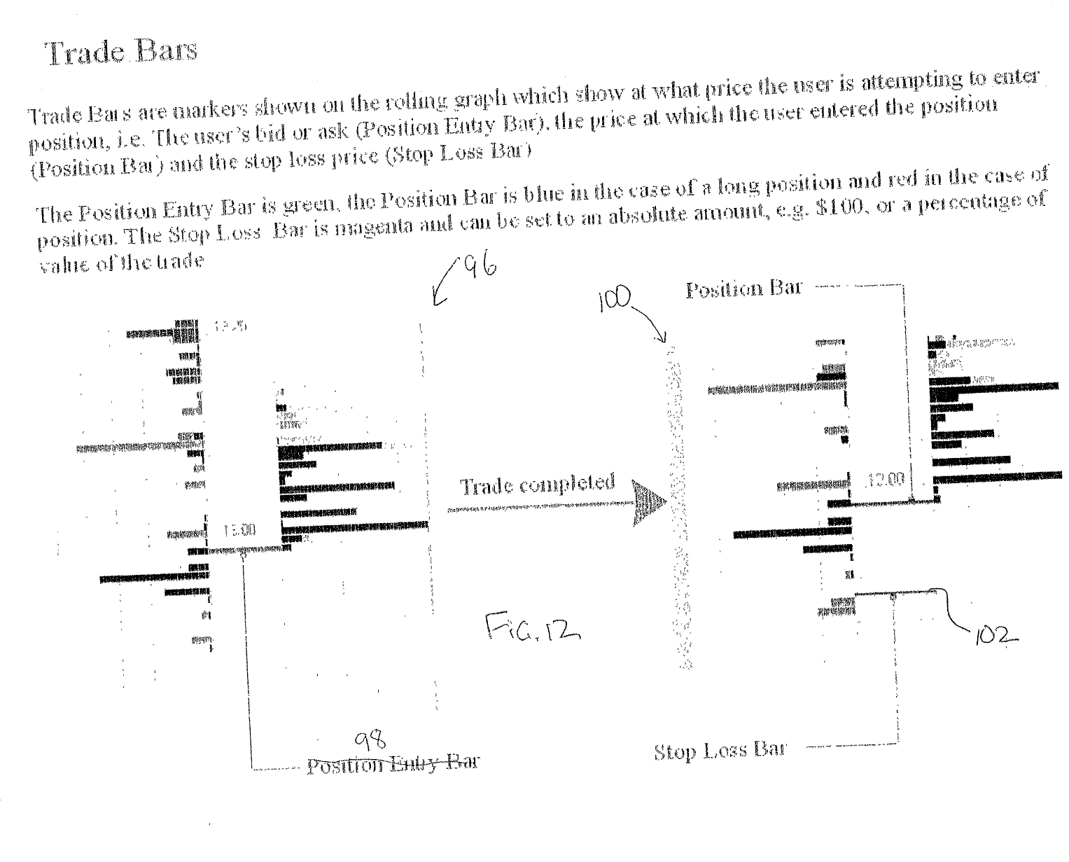

It will further be understood that there may be provided a stop loss bar which indicates to a trader or investor when a predetermined exit price has been reached. In other words, if a trader or investor has entered into a stock market i.e. has purchased a stock, and the price of the stock is decreasing, there is often an impulse by the trader or investor to hold on to the stock in hopes that the price will increase and a profit or break-even point may be reached. However, in order to protect the investor or trader from losing too much money, a stop loss bar may be inserted at a specific price by the trader/investor such that if the stock price goes below the stop loss bar price, the trader or investor is reminded to sell the stock in order to recuperate the remaining money. This is shown in FIG. 12. On a left hand side of FIG. 12, a graphical display 96 shows a trade bar display showing a trader or investor entering the market at $13.00 via a position entry submission bar 98. The position entry bar 98 allows the trader or investor to see how the market is acting compared to their entry price. After entry into the stock market has been achieved, a similar position entered bar 99 is placed on the right hand side graphical display 100. Subsequently, a stop loss bar 102 may be placed below the position entered bar 99. It will be understood that this is the situation when the stock is in a long position. Otherwise, if the stock is in a short position, the stop loss bar 102 is placed at a price level higher than the position entered bar 99. To indicate a short position, the position entered bar 99 is preferably blue while in a long position, the position entered bar 99 is preferably red. The stop loss bar 102 may be placed at an absolute amount of may be placed at a percentage of stock purchase price ($13.00).

Although not shown, when an exit order is submitted for a stock transaction exit, an position exit bar is generated and placed at an exit price level. Once this position is closed, all of the bars are removed from the graphical display.

It will be understood that although specific colours have been described within the invention, the selection of colours is arbitrary and a decision of the person implementing the present invention.

It will also be understood that the increments shown in each of the graphical displays is chosen by the person implementing the method and system of the present invention. The values shown are simply guides and are not meant to narrow the scope of the invention.

It will be understood that although the location of the basic stock information graphical display, the volume of sales graphical display, the bid/ask bar graphical display, the rolling histogram graphical display, the trade bars graphical display, the market makers graphical display are not material to the scope of the invention, by placing the displays as shown in the Figures, the graphical displays may facilitate rapid understanding of the information being displayed.

Another advantage of the present invention is that the number of shares of stocks being sold at each sale price is shown.

Although the invention has been described with reference to certain specific embodiments, various modifications thereof will be apparent to whose skilled in the art without departing from the spirit and scope of the invention as outlined in the claims appended hereto.

What is claimed is:

1. A method of presenting data and analysis for use in stock market trading comprising the steps of:
receiving stock information;
analyzing said stock information to generate historical stock trading information; and
generating at least two graphical displays for displaying said historical stock trading information.

2. The method of claim 1 wherein said graphical displays are colour coded to distinguish between values associated with said historical stock trading information within each of said graphical display.

3. The method of claim 2 wherein said at least two graphical displays are selected from a group consisting of a basic stock information display, a market maker display, volume of sale display, a trade bar display, a bid/ask bar display and a histogram display.

4. The method of claim 3 wherein if one of said graphical displays is said bid/ask bar display, said method further comprising a step of displaying bid/ask bars side-by-side.

5. The method of claim 3 wherein if one of said graphical displays is said histogram display, said method further comprising displaying a three minute volume histogram and an overall volume histogram.

6. The method of claim 5 further comprising a step of providing a three-minute volume bar to indicate a current three-minute minute volume of a maximum three minute volume over a predetermined time interval.

7. The method of claim 3 wherein if one of said graphical displays is said basic stock information display, said method further comprising a step of providing bars to indicate percentage of stock transactions occurring at various price levels during a time interval.

8. The method of claim 7 wherein said bars are colour coded to indicate said percentage.

9. The method of claim 8 wherein a length of said bars also indicates said percentage.

10. The method of claim 3 wherein if one of said graphical displays is said trade bar display, said method further comprising providing a position entry submission bar to indicate a stock market entry price for an individual.

11. The method of claim 10 further comprising the step of providing a stop loss bar for indicating to said individual when a predetermined exit price has been reached.

12. The method of claim 11 wherein said predetermined exit price may be an absolute amount of a percentage of said stock market entry price.

13. The method of claim 1 wherein said stock information is Level II stock information.

14. The method of claim 13 wherein said stock information is received from a stock data provider.

15. A system of presenting data and analysis for use in stock market trading comprising:
a basic stock information display; and
at least two graphical displays showing historical stock information.

16. The system of claim 15 wherein said at least two graphical displays are colour coded to distinguish between values associated with said historical stock information within each of said graphical displays.

17. The system of claim 16 wherein said at least two graphical displays are selected from a group consisting of a basic stock information display, a trade bar display, a market maker display, volume of sale display, a bid/ask bar display and a histogram display.

18. The system of claim 17 wherein if said graphical display is said basic stock information display, said system further comprising bars to indicate a percentage of stock transactions occurring at various price levels during a time interval.

19. The system of claim 18 wherein said bars are colour coded to indicate said percentage.

20. The system of claim 19 wherein a length of said bars also indicates said percentage.

21. The system of claim 17 wherein if said graphical display is said trade bar display, said system further comprising a position entry submission bar to indicate a stock market entry price for an individual.

22. The system of claim 21 further comprising a stop loss bar for indicating to said individual when a predetermined exit price has been reached.

23. The system of claim 22 wherein said predetermined exit price is an absolute amount of a percentage of said stock market entry price.

24. A system of presenting data and analysis for use in stock market trading comprising:
a basic stock information display;
a graphical display showing historical stock information;
wherein said graphical display is a bid/ask bar display including bid/ask bars placed side by side.

25. A system of presenting data and analysis for use in stock market trading comprising:
a basic stock information display;
a graphical display showing historical stock information;
wherein said basic stock information display includes colour coded bars to indicate a percentage of stock transactions occurring at various price levels during a time interval.

26. The system of claim 25 wherein a length of said bars also indicates said percentage.

27. A system of presenting data and analysis for use in stock market trading comprising:
a basic stock information display;
a graphical display showing historical stock information;
wherein said graphical display is a trade bar display including a position entry submission bar to indicate a stock market entry price for an individual.

28. The system of claim 27 further comprising a stop loss bar for indicating to said individual when a predetermined exit price has been reached.

29. The system of claim 28 wherein said predetermined exit price is an absolute amount of a percentage of said stock market entry price.
